(19) United States
(12) Patent Application Publication
(10) Pub. No.: US 2011/0156877 A1
(43) Pub. Date: Jun. 30, 2011

(54) APPARATUS AND METHOD FOR MONITORING REFRIGERATED CONTAINERS

(76) Inventors: Kim Seng Wong, Singapore (SG); Boon Sain Yeo, Singapore (SG); Seng Kee Tan, Singapore (SG)

(21) Appl. No.: 13/054,757

(22) PCT Filed: Jul. 18, 2008
(86) PCT No.: PCT/SG08/00261

§ 371 Date: Jan. 18, 2011

(51) Int. Cl. H04Q 5/22

(52) U.S. Cl. 340/10.1

(57) ABSTRACT

An apparatus (10) for monitoring operational parameters of at least one refrigerated container (12), the at least one refrigerated container (12) having an interrogation port (124), the apparatus (10) comprising a receiver (106) configured to receive data from the refrigerated container (12) via the interrogation port (124), a processor (108) configured to process the data received from the at least one refrigerated container (12), and a transmitter (107) for automatically transmitting processed data to a monitoring centre (14).

### TECHNICAL FIELD

This invention relates generally to an apparatus and method for monitoring refrigerated containers and relates more particularly, though not exclusively, to an apparatus and method for monitoring operational parameters of refrigerated shipping containers.

### BACKGROUND

A refrigerated container typically comprises a relatively standard freight container fitted with a refrigeration system to keep cool the contents of the refrigerated container. For a refrigerated shipping container, power to operate the refrigeration system may be taken from a shore power supply when the refrigerated container is in port, or from a ship's main power supply when the refrigerated container is on the ship.

Refrigerated containers are used to transport goods that need to be kept within a particular range of operational parameters such as temperature and humidity. These may be food or non-food items. The goods may be further categorized as frozen or chilled items. Chilled items are often perishable items. For example, chilled fruits and vegetables continue to respire while they are transported in refrigerated containers from port to port and chemical reactions may continue to take place within the products resulting in a continuous liberation of heat and gases. To prevent spoilage, the refrigeration system must include evaporator fans to draw such heat away from the cargo space more quickly than it is generated.

Considering that the cargo could be items of high value, such as blue-fin tuna or pharmaceutical products, it is in the interest of the shipper, the freight agent, the shipping line and also the port operator that such cargo is safely transported and arrives in good condition at the destination points. To this end, it is necessary to monitor the operational parameters of refrigerated containers to ensure that the contents are maintained within an acceptable range of those operational parameters. With monitoring, action may be taken to correct any anomalies that may affect the condition of the contents. This is especially important for chilled cargo as they are highly temperature sensitive, and the acceptable temperature range is normally very narrow, e.g., ±0.5° C. Cargo damage may occur with small increases or decreases in temperature from a desired set-point temperature.

Currently, the operational parameters may be manually monitored by a technician making periodic rounds on a ship or at a port to visually inspect refrigerated containers located therein. The refrigerated containers may be fitted with a display panel from which the technician can read and take down the levels of the operational parameters. Alternatively, the technician may carry a portable device to download data via an interrogation port fitted to every refrigerated container. The interrogation port is provided with the refrigeration system. It is normally a serial port connected to a data recorder. The data recorder records the data tracked by the refrigeration system. Tracking of atmospheric conditions such as temperature and humidity may be performed by sensors located at various locations within the container box. Besides temperature and humidity, the data may comprise other information such as cooling rates and evaporator fan usage, and so forth.

Presently, there are a handful of manufacturers of refrigeration systems for refrigerated containers. Each manufacturer provides a proprietary data protocol module compatible for processing only data obtained from a refrigeration system of its own manufacture. Various makes of refrigerated containers having refrigeration systems made by the different manufacturers are handled together on ships and at port yards. Consequently, data obtained by the technician from a number of refrigerated containers of different manufacture have to be indicated for subsequent correct processing by their respective compatible data protocol module.

At port, the technician may be able to carry a laptop installed with compatible data protocol modules for manual on-site processing of data from each inspected refrigerated container. On board ship, given that there may be extreme climatic and weather conditions including or resulting in rolling, pitching, extreme cold and rain on deck. Therefore, carrying a laptop to inspect tiers of refrigerated containers is not feasible. The technician may instead carry a hand-held device that connects to the interrogation port to only download and store data. The hand-held device is later connected to a computer to upload the data for data processing. Given the small size of the hand-held device, only data from a limited number of containers may be obtained and stored at the one time, requiring the technician to make several rounds to complete a single inspection of all the refrigerated containers. Consequently, hand-held devices are more commonly used for maintenance rather than actual monitoring of the operational parameters of refrigerated containers.

Currently, in a best case scenario, a typical cycle time of each manual inspection round is about four hours. Under bad conditions at sea, at times, it may be altogether too hazardous for a technician to venture out, so the refrigerated containers may go for long periods without monitoring. It will be appreciated that visual inspection of refrigerated containers at port or on board ship may be an arduous and hazardous process for the technician.

In an alternative to obtaining data via the interrogation port, a refrigerated container may be fitted with one or more additional sensor probes to directly monitor conditions of the interior of the container and transmit information without tapping into the data recorder of the refrigeration system. However, inserting an additional probe or probes requires further modification to a refrigerated container and is intrusive as well as operationally prohibitive.

In attempts to overcome the disadvantages attendant with visual inspection or installing additional probes, to provide consistent live monitoring or a shorter monitoring cycle time of, for example, seconds or minutes, power line transmission systems have been proposed wherein data is transmitted via a standard three-phase power cable that also powers the refrigeration system of the refrigerated containers. By using the power cable, data transmission can take place in both directions, from or to the refrigerated container.

Power line transmissions require a power line modem (slave modem) to be installed on every refrigerated container and at least one master modem installed on board ship and at port. The refrigerated container slots on board ship or at port must also be provided with special sockets that are typically integrated with the refrigerated container power outlets for connecting with a signal cable for data transmission. The costs of fitting refrigerated containers with power line modems and installing ships and ports with the power line transmission systems are prohibitively high. Consequently, most shipping lines have not adopted a power line transmission system, preferring to still rely on technicians to visually inspect and obtain data from refrigerated containers on board ship or at a port yard.

### SUMMARY

In general terms, it is proposed that operational parameters may be automatically obtained from refrigerated containers without requiring modifications to existing refrigerated containers and without requiring a technician to go to a container to visually read or download data. This may provide a cost-effective monitoring system that can be readily implemented for all makes of refrigerated containers with little capital investment and installation. True end-to-end cold-chain monitoring may be achieved as a result of easy portability of the invention between truck, trailer, port yard and ship.

The apparatus and method receive data from the refrigerated container via an interrogation port on the refrigerated container. The apparatus includes a receiver for receiving data from refrigerated containers and a processor for processing the data. Preferably, the processor has a plurality of data protocol modules installed therein and automatically determines which of the plurality of data protocol modules is compatible for processing data from a refrigerated container. A transmitter automatically sends processed data to a monitoring centre.

A record of an interrogated refrigerated container and its compatible data protocol module is preferably maintained in a register such that upon the processor receiving data from a previously interrogated refrigerated container, its compatible data protocol module may be determined from the register.

Preferably, the apparatus is provided with a multiplexer to receive data from a plurality of refrigerated containers and to transmit received data to the processor.

Data transmission between the refrigerated container, the apparatus and the monitoring centre may be performed via cable or wirelessly.

A first aspect is an apparatus for monitoring operational parameters of at least one refrigerated container, the at least one refrigerated container having an interrogation port, the apparatus comprising a receiver configured to receive data from the refrigerated container via the interrogation port, a processor configured to process the data received from the at least one refrigerated container, and a transmitter for automatically transmitting processed data to a monitoring centre.

Another aspect is a method of monitoring operational parameters of at least one refrigerated container, the refrigerated container having a data recorder and an interrogation port, the method comprising receiving data from the data recorder of the at least one refrigerated container via the interrogation port, processing the data, and automatically transmitting processed data to a monitoring centre.

### BRIEF DESCRIPTION OF THE DRAWINGS

In order that the invention may be fully understood and readily put into practical effect there shall now be described by way of non-limitative example only exemplary embodiments, the description being with reference to the accompanying illustrative drawings.

In the drawings:

FIG. 1 is an architecture diagram illustrating an apparatus for monitoring data of at least one refrigerated container;

FIG. 2 is a flowchart of a method of monitoring data of at least one refrigerated container

### DETAILED DESCRIPTION OF EXEMPLARY EMBODIMENTS

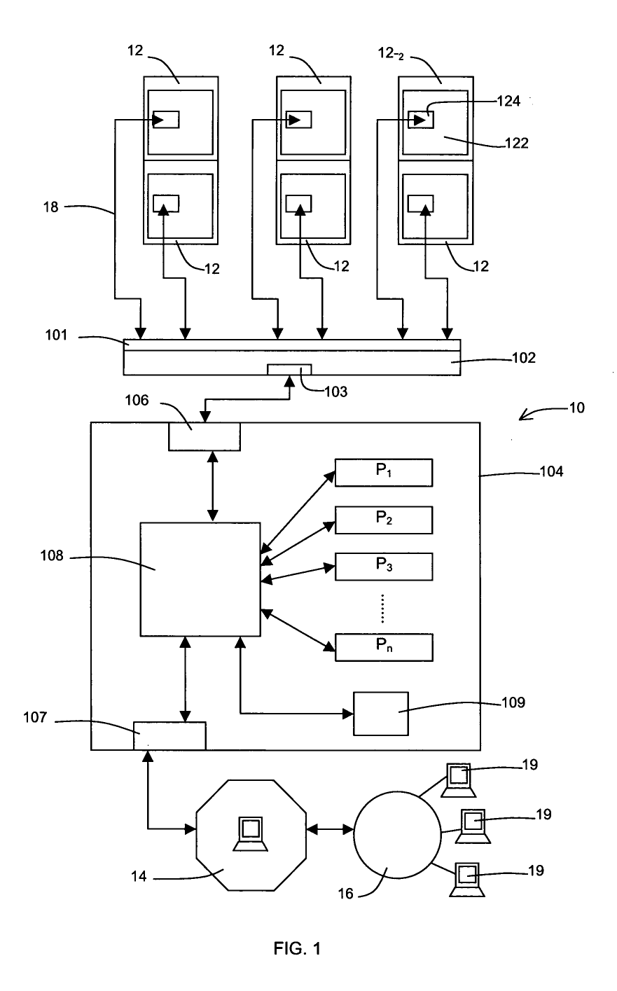

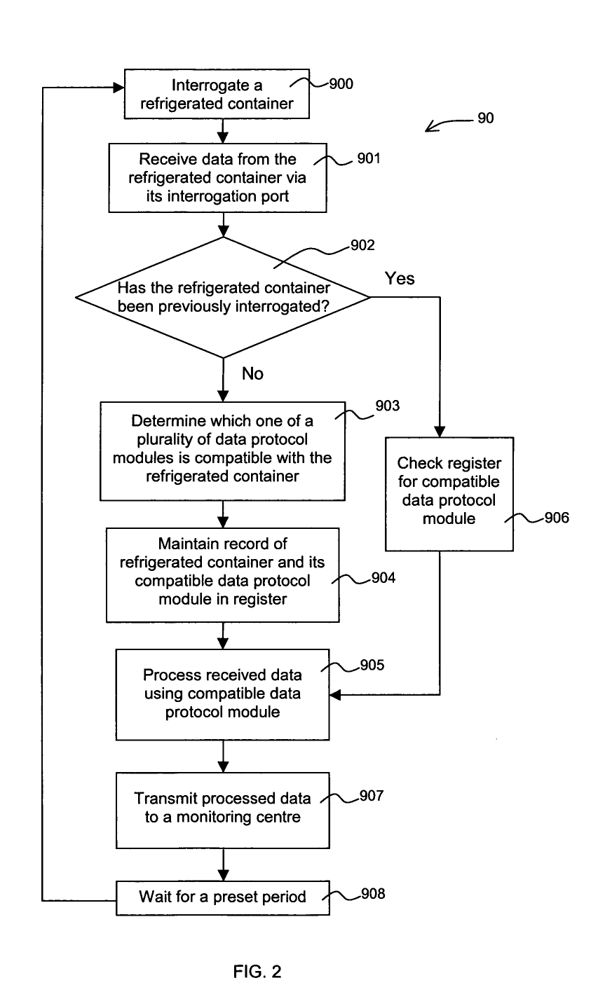

As shown in FIGS. 1 and 2, there is provided an apparatus 10 and a method 90 for receiving and processing data from at least one refrigerated container 12 for subsequent transmission to a monitoring centre 14. Arrows in FIG. 1 indicate possible directions of data flow.

Each refrigerated container 12 is cooled by a refrigeration system 122. The refrigeration system 122 is made by any one of a number of refrigeration system manufacturers M₁ to Mₙ). Each manufacturer M₁ to Mₙ provides a proprietary data protocol module P₁ to Pₙ for processing data from a refrigeration system 122 of its own manufacture.

The refrigeration system 122 includes sensors that monitor the atmospheric conditions of the interior of the refrigerated container 12 for information such as temperature and humidity. A data recorder in the refrigerated container 12 stores data comprising information from the sensors as well as other information of the refrigeration system 122, such as cooling rates and evaporater fan usage. Each refrigerated container 12 also has an interrogation port 124 located on its exterior. The interrogation port 124 comes with the refrigeration system 122 and is typically a serial communication port. Data from a refrigerated container may thus be downloaded via its interrogation port 124 to an external device for processing.

The apparatus 10 preferably comprises a computer 104 having a receiver 106 for receiving data from the refrigerated containers 12, 901 and a processor 108 for processing the received data 905. Preferably, the apparatus 10 includes a multiplexer 102 having an input channel 101 for receiving data downloaded from a plurality of refrigerated containers 12 and for sending interrogation signals from the apparatus 10 to the refrigerated containers 12. The multiplexer 102 is preferably in serial communication with the plurality of refrigerated containers 12. Serial communication cables 18 may be provided, each serial communication cable being connected to an interrogation port 124 and to the multiplexer 102. Similarly, an output channel 103 of the multiplexer 102 is preferably in serial communication with the receiver 106. The receiver 106 may be a serial communication input port, a USB port, or any other port suitably adapted for receiving serial input.

Alternatively, there may be provided a wireless adaptor at each of the interrogation ports 124 to wirelessly transmit data or interrogation signals between the refrigerated containers 12 and the receiver 106. Medium Access Control (MAC) protocol is preferably used by the receiver 106 to receive such wireless transmissions. Communication between the refrigerated containers 12 and the multiplexor 102, or between the multiplexor 102 and the receiver 106, may also be performed wirelessly.

Preferably, the processor 108 is configured to automatically periodically interrogate each of the plurality of refrigerated containers 12, 900 by sending an interrogation signal through the receiver 106 to the interrogation port 124 of each refrigerated container 12. In this way, data from the refrigerated containers 12 may be regularly obtained. The period of interrogation may be as frequent as a matter of seconds, or may be several minutes, depending on the number of refrigerated containers 12 in electronic communication with the apparatus 10. Under exception handling, a specific request can be made to poll a particular container 12 for information. Monitoring of the refrigerated containers 12 may also be conducted based on predetermined date/time settings, or by a predetermined number of interrogations for each trip of a refrigerated container 12. Monitoring may alternatively be activated by a user through a monitoring centre 14 via ad hoc requests for information. Activation may be made with a mouse click, by pressing a button, by keying in a specific request for information, or any other appropriate activation format.

The processor 108 and/or a memory associated with the processor 108 preferably has a plurality of data protocol modules P₁ to Pₙ installed therein. Each data protocol module P₁ to Pₙ is the proprietary data protocol module provided by the manufacturer M₁ to Mₙ of a refrigeration system for containers and is compatible for processing only data obtained from a refrigeration system of each manufacturer M₁ to Mₙ. The processor 108 is preferably configured to automatically determine which one of the plurality of data protocol modules P₁ to Pₙ is compatible for processing data downloaded from a particular refrigerated container 12. Preferably, all the proprietary data protocol modules provided by all the manufacturers of refrigeration systems for containers are installed in the processor 108. In this way, the processor 108 can process data received from any make of refrigerated container that is in electronic communication with the apparatus 10.

When data from a particular refrigerated container (for example container 12-₂ having a refrigeration system made by a manufacturer M₂) is received for a first time in a first interrogation by the processor 108, 901, in order to determine which one of the plurality of proprietary data protocol modules P₁ to Pₙ is compatible for processing that data 903, a processor 108 in the processor 108 may poll the plurality of data protocol modules P to Pₙ for a match with the data received from the refrigerated container 12-₂. Preferably, the poll is conducted sequentially. For example, upon finding that proprietary data protocol module P₁ is not compatible with the data from the refrigerated container 12-₂, the processor moves on to poll proprietary data protocol module P₂. Upon finding a match, a record of the refrigerated container 12-₂ and its compatible data protocol module P₂ is preferably maintained in a register 109, 904. Data from the refrigerated container 12-₂ is then automatically processed by its compatible data protocol module P₂, 905. Alternatively, data from the refrigerated container 12-₂ may be processed prior to or concurrently with maintaining a record of the refrigerated container 12-₂ and its compatible data protocol module P₂. Polling of the plurality of data protocol modules P₁ to Pₙ for a match with a particular container 12 may be performed in parallel instead of sequentially.

Maintaining a register 109 specifying which one of the plurality of data protocol modules P₁ to Pₙ is compatible with which refrigerated container 12 is made possible by each refrigerated container having a unique identification code. This allows the refrigerated container to be identified and “remembered” by the processor 108 together with its compatible data protocol module. In this way, after a first interrogation of a refrigerated container 12 and detection of its compatible data protocol module by the processor 108, for subsequent interrogations of that refrigerated container 12, by looking up the register 109, 906, the processor 108 can immediately call up its compatible protocol module to process the data 905. In this way, the processor 108 may skip the step of polling through the plurality of data protocol modules P₁ to Pₙ again. For every interrogation of a refrigerated container 12, therefore, the processor 108 preferably first checks if that particular refrigerated container 12 has been previously interrogated 902, so that polling of the plurality of data protocol modules is performed only for refrigerated containers that have not previously been interrogated.

After the data from a refrigerated container 12 has been processed by the processor 108, the processed data is automatically transmitted to a monitoring centre 14, 907 via a transmitter 107 on the apparatus 10. The processor 108 preferably comprises application modules for presenting the processed data in a layout appropriate for display at the monitoring centre 14. The application modules may be integral with the proprietary data protocol modules P₁ to Pₙ. The processor 108 may then wait for a preset period 908 before interrogating another or the same refrigerated container 12. Preferably, the transmitter 107 also channels interrogation requests from the monitoring center 14 to the refrigerated containers 12. Transmissions between the apparatus 10 and the monitoring centre 14 may be via cable connection between the transmitter 107 and the monitoring centre 14, or the transmitter 107 may be a wireless device for wireless transmissions between the apparatus 10 and the monitoring centre 14.

At the monitoring centre 14, if the processed data transmitted from the processor 108 indicates that any of the operational parameters of a refrigerated container 12 has deviated from an acceptable value, an alarm may be triggered. Various threshold values may be preset for each refrigerated container, preferably at the monitoring centre 14, so that processed data received by the monitoring centre 14 may be checked against these threshold values to determine if an alarm should be triggered. Processed data received by the monitoring centre 14 may be displayed on a user interface at a terminal at the monitoring centre 14.

The monitoring centre 14 may be in a control room on a ship, at port, or at another location. A plurality of monitoring centres 14 may be provided if desired. Processed data sent to the monitoring centre 14 may further be made accessible via Internet 16. In this way, any authorised person or persons may simply use any computer 19 having an Internet connection to go online to track that goods being shipped in a refrigerated container 12 that is being monitored by the apparatus 10 and method 90 are maintained within acceptable conditions. The invention may also be configured to track the location of a particular container 12 using its unique identification code. Online tracking of the operational parameters and location of a refrigerated container 12 may be provided by shipping lines and/or port operators as a premium service to their customers. Alternatively, the monitoring centre 14 may be connected to an intranet or other appropriate networks as user requirements may determine.

Being of a portable size, the apparatus 10 may be readily provided at various points of container handling. These include locations of cargo loading and unloading, on trucks or trailers, on ships, and at ports. By providing a portable apparatus 10 that can obtain information generically from all makes of refrigerated containers 12 using existing hardware provided on the refrigerated containers, true end-to-end cold chain monitoring of refrigerated containers 12 may be achieve without requiring new devices to be added to the refrigerated containers or expensive infrastructural installations to be made to ships or ports.

In future, a standardized protocol module may be able to process data from all makes of refrigerated containers. In a further exemplary embodiment of the invention for monitoring operational parameters of refrigerated containers, the receiver 106, processor 108 and transmitter 107 are preferably packaged such that the apparatus 10 is compact enough to plug directly into the interrogation port 124 of a refrigerated container 12 via the receiver 106. Data from the refrigerated container 12 passes from the interrogation port directly to the receiver 106 and is automatically processed by the processor 108 using the standardized protocol module installed in the processor 108. Processed data is then automatically transmitted by the transmitter 107 to the monitoring centre 14. Preferably, the transmitter 107 is wireless for sending wireless transmissions from the apparatus 10 located at the interrogation port of the refrigerated container 12 to the monitoring centre 14.

Whilst there has been described in the foregoing description exemplary embodiments of the present invention, it will be understood by those skilled in the technology concerned that many variations in details of design, construction and/or operation may be made without departing from the present invention. For example, wireless transmissions between a refrigerated container, the apparatus and the monitoring centre may be via WiFi, WiMAX, or satellite transmissions. Connection of the monitoring centre with the Internet may be wired or wireless. The apparatus may be placed near refrigerated containers being monitored, by cabling together the refrigerated containers and the apparatus on a ship's deck or at a port yard. Alternatively, using wireless transmissions, the apparatus may be located in a control room of the ship or port. In future where a standardized protocol module may process data from all makes of refrigerated containers, the apparatus 10 may be placed at the interrogation port of each refrigerated container.

1. An apparatus for monitoring operational parameters of at least one refrigerated container, the at least one refrigerated container having an interrogation port, the apparatus comprising:
a receiver configured to receive data from the refrigerated container via the interrogation port;
a processor configured to process the data received from the at least one refrigerated container; and
a transmitter for automatically transmitting processed data to a monitoring centre.

2. The apparatus of claim 1, further comprising a plurality of data protocol modules therein, one of the plurality of data protocol modules being compatible for processing the data received from the at least one refrigerated container, the processor being configured to automatically determine the compatible one of the plurality of data protocol modules.

3. The apparatus of claim 2, wherein each of the plurality of data protocol modules is a proprietary data protocol module of a refrigeration system manufacturer, each proprietary data protocol module being able to process only data from a data recorder of a refrigerated container installed with a refrigeration system from that manufacturer.

4. The apparatus of claim 2, wherein the processor is configured to maintain a register specifying which one of the plurality of data protocol modules is compatible for processing data received from a particular one of a plurality of refrigerated containers.

5. The apparatus of claim 1, further comprising a wireless adaptor for connection to the interrogation port for wireless transmission of data from the refrigerated container.

6. The apparatus of claim 1, further comprising a multiplexer for receiving data from a plurality of refrigerated containers and for transmitting the data from each of the plurality of refrigerated containers to the processor.

7. The apparatus of claim 6, wherein the multiplexer comprises a wireless input channel for receiving wireless transmissions from a wireless adaptor configured for connection to the interrogation port for wireless transmission of data from the refrigerated container.

8. The apparatus of claim 6, wherein the multiplexer comprises a wireless output channel for wireless transmission of data from each of the plurality of refrigerated containers to the receiver.

9. The apparatus of claim 1, wherein the receiver is a wireless receiver for receiving wireless transmissions of data.

10. The apparatus of claim 1, wherein the transmitter is a wireless transmitter for wireless transmission of processed operational data to the monitoring centre.

11. The apparatus of claim 1, wherein the monitoring centre is configured to be accessible via Internet.

12. A method of monitoring operational parameters of at least one refrigerated container, the refrigerated container having a data recorder and an interrogation port, the method comprising:
receiving data from the data recorder of the at least one refrigerated container via the interrogation port;
processing the data; and
automatically transmitting processed data to a monitoring centre.

13. The method of claim 12, further comprising, before processing the data, automatically determining which one of a plurality of data protocol modules is compatible for processing the data.

14. The method of claim 13, wherein the determining includes polling the plurality of data protocol modules for a match between one of the plurality of data protocol modules and the received data.

15. The method of claim 13, further comprising maintaining a register specifying which one of the plurality of data protocol modules is compatible for processing data received from a particular one of a plurality of refrigerated containers.

16. The method of claim 12, wherein the receiving includes receiving data from a plurality of refrigerated containers using a multiplexer and communicating the data from the multiplexer to the processor.

17. The method of claim 16, wherein the communicating is performed wirelessly.

18. The method of claim 12, wherein the receiving is performed wirelessly.

19. The method of claim 12, wherein the transmitting is performed wirelessly.

20. The method of claim 12, further comprising accessing the monitoring centre via Internet for online monitoring of transmitted processed data.
